(19) United States
(12) Patent Application Publication
(10) Pub. No.: US 2007/0290816 A1
(43) Pub. Date: Dec. 20, 2007

(54) Portable health food pantry and method for managing a diet plan

(76) Inventor: William Bedard, Lowell, MI (US)

Correspondence Address: CHRISTOPHER D. HARRINGTON, SUITE 350, 5300 CORPORATE GROVE DRIVE SE, GRAND RAPIDS, MI, 49512, US

(21) Appl. No.: 11/454,641

(22) Filed: Jun. 19, 2006

(51) Int. Cl. G08B 1/00

(52) U.S. Cl. 340/309.7

(57) ABSTRACT

A novel portable food pantry is disclosed comprised of a cooler portion with an insulated body for the storage of foods, including drink storage, nutritional supplement storage and/or vitamin storage. The portable food pantry of the present invention may also include storage for medication and medical supplies. The portable food pantry of the present invention is used in conjunction with a method for providing multiple meals in accordance with a food plan for a person.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to food storage article and a method for using same within a specific dietary plan. More particularly, the present invention relates to a portable food pantry that is capable of safely retaining food products, nutritional supplements, dietary tools, that would be supportive of a specific health food plan for an individual.

With advancements in the understanding of human nutrition and the biochemistry of metabolism, there have been improvements in the nature and type of diets that have been developed. In particular, diets have become more and more targeted and can be so specific as to become therapeutic tools for certain types of situations. For instance, diets are normally associated with weight loss objectives, and while the dietary considerations for various individuals in a weight loss program will vary, the concept of diet plans extends far beyond weight loss issues, as important as this subject may be.

Diet plans can be established for athletes who strive to build muscle, strengthen their joints, and for the development of endurance or other attributes that may be deemed to be performance related factors. In other situations a diet plan can be directed towards a metabolic disease like diabetes. There are cases where diet plans are successful in managing juvenile and adult diabetes, and there are well known cases where gestational diabetes has been completely managed through the use of diet plans alone. In addition to diet plans that are directed towards particular results, e.g., adding to muscle tone, or muting a metabolic disease, there are diet plans that are merely discretionary. For instance, some people choose vegetarian lifestyles or fruitarian lifestyles which require intense focus on diets and meal planning. While the health benefits of such lifestyles may have much to recommend them for adoption, the relationship between the diet plan and a desired outcome may not be as tangible effects, yet the need exists for the user to be able to manage his/her choices during the day.

Certainly most diet plans do look towards regulating “what” a person is eating, but there are many other factors that are of concern as well. The size of the portion is considered, nutrition is considered and many times this results in the introduction of nutritional supplements, and in some cases specific types of vitamins or supplements may be needed to achieve a result. The timing of meals is a consideration as well as the number of meals that a person might be having throughout the day. Obviously there are a large number of parameters that a nutritionist or similarly skilled person will take into account when setting out a diet plan.

One of the long-standing problems with respect to the implementation of a diet plan has been the availability of the meals, supplements, vitamins and other elements that make up the particular approach. Many people have found it difficult to prepare the elements of their food plan only to have to confront the problems associated with transporting the components to a work place, to school, or to some other required work location, or sporting event, etc. In essence, the popularity of fast food restaurants bears witness to this very problem since today's mobile society has come to rely upon the availability of readily accessible foods. The obvious downside to this is the fact that the fast food menus do not have offerings that are consistent with the goals of a diet plan in the usual case, in fact, the fast food offerings are typically antithetical to the goals and objectives of any well developed food plan.

Considerations in any approach relating to the portability of a food plan would have to include the ability to maintain the parameters that have been determined. This means that the portions must be quantifiable, there must be provisions for supplements and/or vitamins and the like, there needs to be a competent means for the preservation of the foods (spoilage would clearly defeat the purposes of any plan), and there should be the ability to provide the tools that are necessary for complying with food plans. This could also apply to medications that may be required for the user as well. The types of tools contemplated include timers, scales, measuring equipment, references and the like. These are items that are not found in the usual cold pack and the arrangement and storage of these elements requires different capabilities for any portable container that might be compatibly utilized.

There are portable food containers known in the prior art that are useful for holding foods for periods of time and for use in places outside the home. For instance, in U.S. Pat. No. 6,296,165 (Mears) a storage bag is disclosed that has side storage for holding drinks and devices (such as a cell phone). The bag is insulated and has a carrying handle for portable use. Mears, however, does not teach a bag that works in conjunction with adherence to a food plan. Also, in U.S. Pat. No. 6,105,844 (Walters, et al) a cooler is shown that has external storage space for stored goods as well as the conventional enclosed storage area. The storage bag of Walters is deemed portable and works to keep food and beverage items cool until used. Walters is primarily concerned with a cooler that is highly accessible to the user and does not provide service for use in conjunction with a specialized food plan.

U.S. Pat. No. 5,842,571 (Rausch) teaches the use of a soft-sided cooler to store a prepared meal in individual containers. Rausch is focused on the ability to modify the compartmentalization of the cooler to accommodate different items, including segregating areas between hot and cold. Rausch does not teach a storage and container system that coordinates with a food plan of any kind, in fact, Rausch is directed towards providing a solitary meal for the user, rather than providing multiple meals/snacks.

Notwithstanding the advancements in the prior art, there still remains a longstanding impediment for those who desire to extend the benefits of their nutritional or medical diet plans outside the home environment. While it is possible for people to use the soft-sided and hard-sided coolers for transporting their foods with them, these products are designed around pre-existing dimensions that relate more to the size of beverage cans. Even in circumstances where the cooler design is more accommodating, it does not have the ability to maintain all of the supplements, vitamins, and tools in an organized fashion that would be necessary to implement a sophisticated food plan. The integration of all of the components used in a food plan into a portable storage device is necessary to support the plan itself and without a means for providing these in a single and convenient package, it becomes very time consuming and cumbersome for the user to adhere to the plan.

As will be seen below, a novel portable food pantry has been devised for use with dietary and medical food planning purposes. The portable food pantry of the present invention overcomes the shortfalls evidenced in the prior art and provides an effective and convenient tool for a user that will serve to facilitate the implementation of the food plan and will thereby help to encourage its continuation.

### SUMMARY OF THE INVENTION

A novel portable food pantry comprises a cooler portion with an insulated body that includes segregate meal storage, drink storage, supplement storage and vitamin storage portions, and a tool storage portion. The insulated body also includes a carrying strap and an insulated lid for enclosing some of the storage areas. The portable food pantry also includes a timer that is preferably attached to the insulated body and which provides a visual or audible notice when an element of the food plan is reached. In an alternate mode, the timer may be reversibly attachable.

A portable food pantry of the present invention is compatible for use in a food plan, the steps of which include the selection of a plan for the user, the acquisition of the foods and supplements for use in the plan, preparation of the foods, quantification of the foods to be used for a select period of time in accordance with the plan, the placement of the foods and supplements into containers compatible with storage in the storage portions of the portable food pantry, execution of the plan through the selected period of time. In addition, the steps may include the storage of tools in compatible storage portions of the portable food pantry, and the use of tools in accordance with requirements of the plan.

Other enhancements of the portable food pantry of the present invention include the addition of a locking feature to lock the lid to the cooler in order to protect the integrity of the foods contained within the cooler. The need for security also applies to the protection of medications such as insulin and the related equipment such as syringes or needles.

The cooler of the present invention is preferably comprised of a soft-sided insulated body.

These and other attributes and benefits of the present invention will be discussed in more detail within this specification.

### BRIEF DESCRIPTION OF THE DRAWINGS

FIG. 1 is a side view of a portable food pantry of the present invention, shown with the lid closed and the snaps engaged.

FIG. 2 is a top cross sectional view of the portable food pantry of FIG. 1 taken along Section Lines 2-2, showing the storage portions of the invention.

FIG. 3 is a side elevational view of the portable food pantry of FIG. 1.

FIG. 4 is a front view of a digital timer for use with the portable food pantry of the present invention.

FIG. 5 is a front cross sectional view of the portable food pantry of FIG. 3, taken along Section lines 5-5, showing the storage portions of the present invention.

FIG. 6 is a top view of a portable food pantry of FIG. 1, with the lid in the closed position and the snaps engaged and with the digital timer affixed to the front.

FIG. 7 is a side elevational view of a food container for use with the portable food pantry of the present invention.

FIG. 8 is a side elevational view of three food containers of the type disclosed in FIG. 7, showing the three food containers in a nested stacking condition.

FIG. 9 is a front cross sectional view of the portable food pantry of FIG. 1, showing a set of food containers stacked in a portion of the interior.

FIG. 10 is a front cross sectional view of the portable food pantry of FIG. 1, showing a set of larger food containers stacked in the interior.

### DETAILED DESCRIPTION OF THE PREFERRED EMBDOIMENTS

A novel portable food pantry in accordance with the present invention comprises a cooler with an insulated body which is segregated into meal storage, drink storage, supplement storage and vitamin storage portions, and a tool storage portions. As will be understood herein and through the drawings, the portable food pantry is functionally related to a food plan that is selected for or by a user. To that end, the need for a food plan and illustrations of various types of food plans are discussed first. The food plan may actually comprise a written plan that can be included within the portable food pantry as a ready reference.

One food or diet plan that is known is the “Body for Life Plan” that was created by Bill Phillips, the founder of EAS a company that manufactures dietary supplements. The Body for Life plan is based upon the premise that a diet that produces fairly quick results will encourage the user to stick with it. Phillips does recommend the use of his company's supplements in conjunction with a nutritionally sound food plan in order to generate gradual weight loss within a healthy context. The plan's focus includes the recommendation for staging multiple meals throughout the day, typically six such meals of calculated size and content, intended to maintain constant energy levels, reduce the usual “starvation response” that is experienced in most diets, and to encourage muscle development that will further increase the participant's metabolism. The foundation for the Body for Life plan, therefore, does include the multiple meal plan, with specific meal parameters and with a recommendation for supplements for maximum benefit to the participant.

Another weight loss food plan is offered by the founder of the “Curves” fitness franchises. Gary Heavin is a proponent of a nutritional theory that says that each individual has an internal “set-point” where their metabolism kicks in as far as mobilizing stored fat reserves. A central theme of Mr. Heavin's program, much like the Body for Life plan, is the use of multiple meals for maintaining a nearly constant level of caloric intake with the proposed benefits being the encouragement of the participant's metabolism to increase as a result. Mr. Heavin acknowledges somewhat indirectly, the difficulties associated with compliance with the multiple meal approach by offering suggestions as to how to compatibly work restaurant meals into one's daily routine.

At the other end of the food plan spectrum from the Body for Life plan, are those plans designed for weight gain. Surprisingly, similar considerations and parameters are involved in weight gain plans as there are for weight loss plans. For instance, multiple meals are recommended rather than three medium or large meals. Increasing portion size is not a healthy way to generate weight gain since it can be disruptive to body chemistry and can lead to other health problems down the road. Snacks are encouraged in weight gain plans although these need to be spaced in order to encourage steady caloric levels which combined with spaced multiple meals, assists in building muscle when the plan is used in conjunction with an exercise program.

There are food plans that are related to medical conditions, among the most notable are the food plans that are directed towards person with diabetes. Web MD offers the following advice for diabetic related dietary considerations:

“Eat a wide variety of foods. Having a colorful plate is the best way to ensure that you are eating plenty of fruits, vegetables, meats, and other forms of protein such as nuts, dairy products, and grains/cereals.

### Maintain a healthy weight.

Choose foods high in fiber such as whole grain breads, fruit, and cereal. They contain important vitamins and minerals. You need 25 to 35 grams of fiber per day. Studies have shown that people with type 2 diabetes who eat a high fiber diet can improve their blood sugar and cholesterol levels. Similar results have been shown in some studies in people with type 1 diabetes.
Watch your portions. Eat only the amount of food in your meal plan. Excess calories results in excess amounts of stored energy from food which results in excess fat and excess weight. In people with type 2 diabetes excess body fat means less sensitivity to insulin. The dietitian will help you determine what portion sizes you can eat. This will be determined based on many things such as whether you need to lose weight, maintain weight, have high sugars or suffer from low sugars.

### In women with gestational diabetes, eat multiple meals and snacks per day as recommended.

### Do not skip meals.

Eat meals and snacks at regular times every day. If you are taking a diabetes medicine, eat your meals and take your medicine at the same times each day.”
Again the admonitions include the usage of multiple meals for persons experiencing gestational diabetes, but the other parameters are very comprehensive as well. There is a great deal of emphasis on the spacing or timing of meals as well as the size of portions and the diversity of food stuffs. This complexity raises problems for the participant in terms of managing their food plans while trying to maintain a modern lifestyle that incorporates work, school, parenting, and the like.

There are many other food plans that are directed towards differing objectives. These can be related to medical issues such as cancer recovery, or they can be performance related for athletes, or they can relate to lifestyles such a vegetarianism or fruitarianism. The benefits of the present invention extend to all of these food plans since the portable food pantry facilitates compliance with the particular food plan assisting the participant and increasing the chances for a successful outcome.

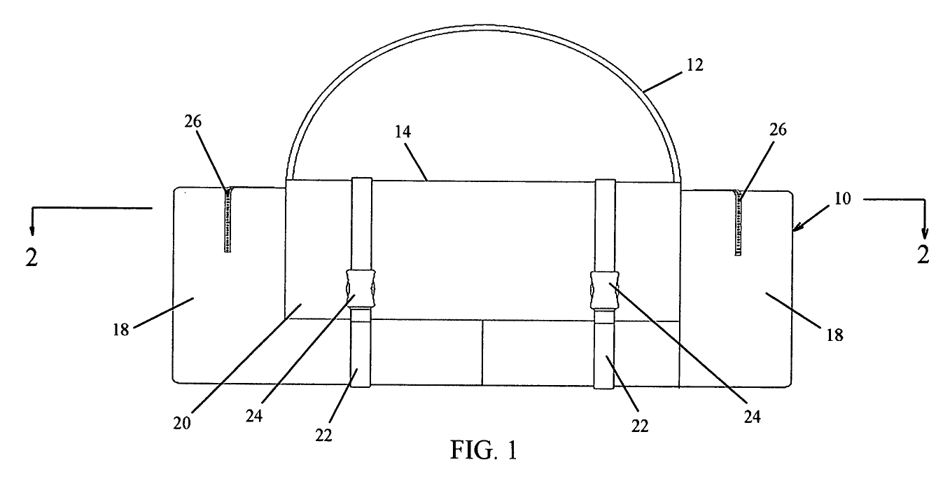

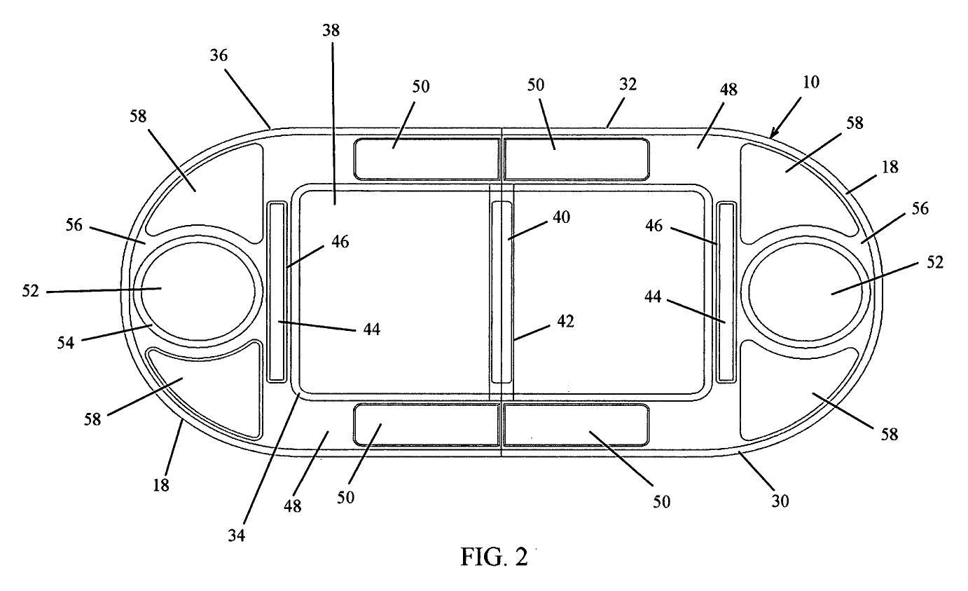

Turning now to the drawings, a portable food pantry 10 is shown in FIG. 1, with a carrying strap 12, and with the top 14, the bottom 16, the side portion(s) 18, the lid 20 and with associated lid straps 22 and snaps 24. Also shown are the zippers 26 which provide access to the interior of the side portions 18. More details of the food pantry 10 can be seen in FIG. 2, with the pantry front 30, the back 32, the inner sidewalls 34, the outer sidewalls 36, the pantry interior 38, the middle sleeve 40, the middle sleeve walls 42, the side sleeve(s) 44, the side sleeve walls 46, pantry insulation 48, storage sleeves 50, bottle storage 52, the bottle storage sleeve wall 54, the bottle storage support wall 56, and the thermal sleeve(s) 58 which can be accessed through the zippers 26.

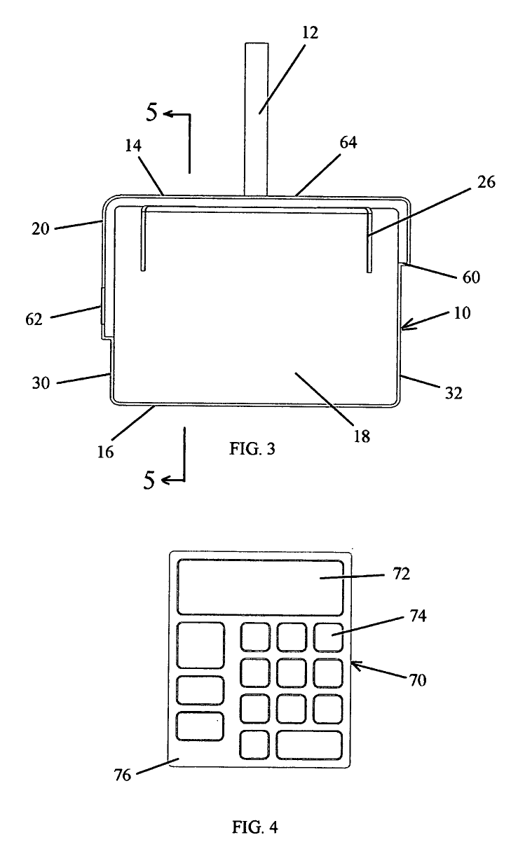

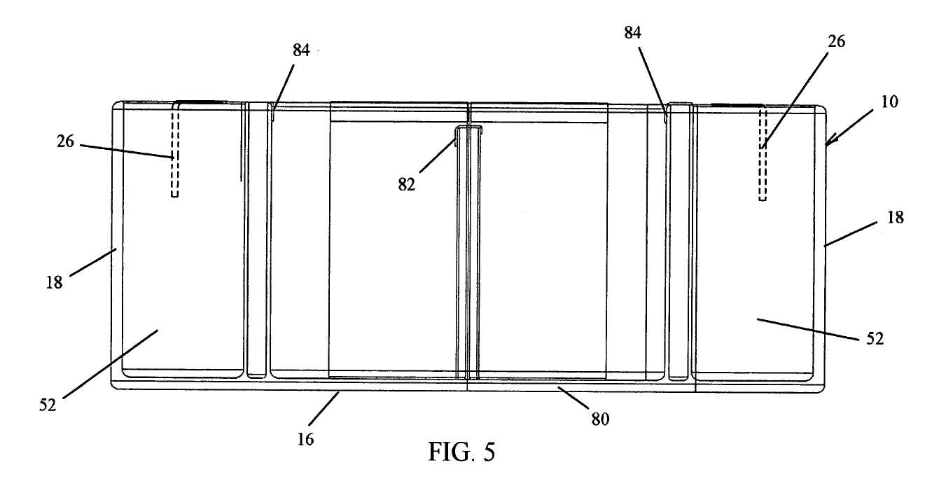

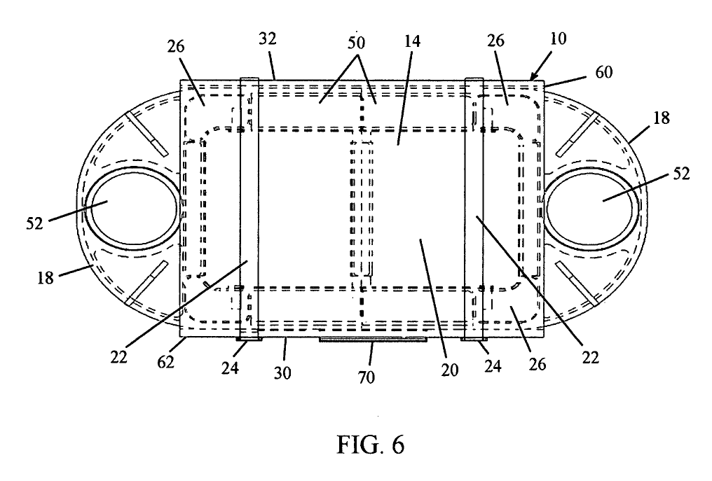

In FIG. 3, the portable food pantry 10 is shown from the side showing the lid hinge point 60 with the lid flap 62 and lid insulation 64. A digital timer/calculator 70, is seen in FIG. 4, and includes the display 72, input keys 74 and the housing 76. More of the portable food pantry 10 is revealed in FIGS. 5 and 6, showing the bottom insulation 80, the mid-sleeve top 82 and the sleeve top(s) 84.

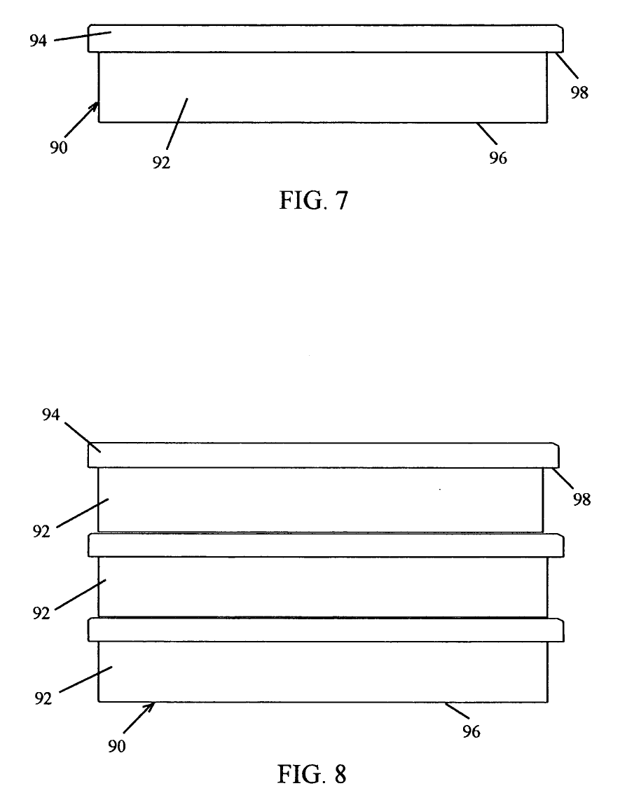

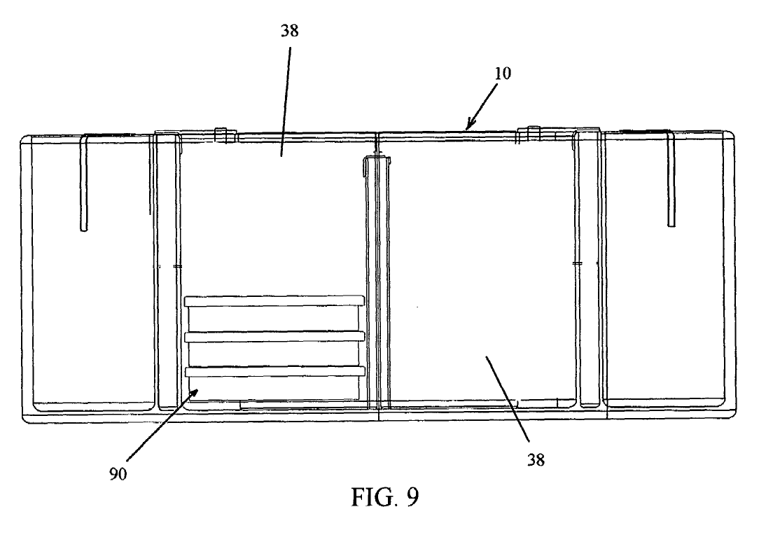

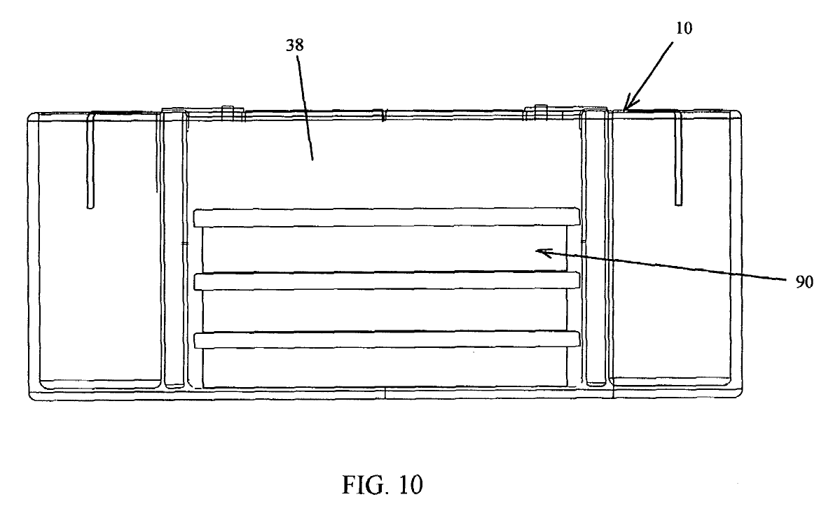

In FIGS. 7, 8, 9 and 10, a food container 90 for use with the portable food pantry 10 of the present invention is shown. In particular, the food container 90 includes the dish portion 92, the dish top 94, with the dish portion 92 including a dish bottom 96 and the dish top 94 including the top edge 98. In FIG. 8, the food container(s) 90 is shown stacked with other food containers 90. Similarly, in FIG. 9, stacked food containers 90 sized to match approximately half of the pantry interior 38 are displayed, and in FIG. 10, stacked food containers 90 sized for use in the full width of the pantry interior 38 are shown.

The food pantry of the present invention is preferably constructed as a soft-sided cooler although it need not be exclusively so. Soft-sided cooler construction is well known in the prior art, but in the present invention it is segregated to be used in accordance with a desired food plan. The size of the food pantry may vary without detracting from the benefits of the concept so long as the essential functionality of the product is retained. The food pantry is meant to provide sufficient storage capability for a person to carry the components of their food plan with them throughout the course of a day. This includes not only the meals, but also any supplements, seasonings, tools, drinks and any other item that may be needed. Each aspect of these components will be discussed below. Examples of tools that may be used in accordance with the present invention includes bottle and/or can openers, eating utensils, knives, corkscrews, graters, and the like.

The meals used in a food plan are typically selected on the basis of content, with factors ranging from calories, carbohydrates, fats, proteins, vitamins, and the like. This selection is also typically made in conjunction with a quantifier such as weight or size. In this way each meal can be prepared and placed in a food container with the assurance that it represents a specific factor in the person's food plan. Each food container can also be marked or segregated to further provide guidance as to the effect of a portion. As can be appreciated from the drawings, the food containers can be stowed within the portable food pantry which is insulated. Typically the objective will be to keep the meals chilled until they are ready to be used, thus the sleeves and the mid-sleeve can have cold packs inserted in order to keep the temperature at the desired levels. The cold packs are supplied in sufficient quantity to keep the foods or medications cold enough to prevent degradation. The same is true with respect to the thermal sleeves that surround the bottle storage portions. The food pantry may be viewed in this situation as a cooler with the sidewalls enclosing a cooler body. The converse could be true as well; the food pantry could be used to keep heated foods warm for a period of time, and as would be expected, there would be no need for any cold packs in this case. It has been the applicant's observation, however, that the most prevalent usage is for chilled storage. Nonetheless, the food containers are preferentially compatible with both freezing and microwave use.

The use of supplements is very often an adjunct to any comprehensive food plan. Many times there is a need however to have access to the supplements at times other than the time a meal is being accessed. For instance, nutritional or energy bars or snacks may comprise part of a food plan and the consumption of these supplemental foods is typically spaced between meals for the purposes described above. In addition there are supplements such as vitamins, oils, food proteins, and the like that may be needed with meals or at discretionary moments. Accessibility for these types of supplements is also of importance. For these reasons, the storage sleeves are provided to segregate such supplements from the interior of the food pantry, and in accordance with the invention, the storage sleeves may be removeable which allows some variation in the quantity and type of food containers that can be used. With several different sleeves to choose from, the supplements (and as will be discussed shortly, the tools) can be organized and made easily accessible. Many times the supplements are not required to be kept in a chilled environment so the usage of the sleeves in this fashion is appropriate even though they don't receive the full benefit of the cold packs that are installed in the food pantry.

The food pantry of the present invention provides for the storage of bottled drinks. These are stored on the bottle storage portions and as alluded to above, this region may be kept chilled through its proximity with the sleeve storage where cold packs may be installed, abut also through the thermal sleeves which may also contain a cooling source. As configured, the bottle storage is kept exterior (to the sides) of the central portion of the cooler body where the interior of the food pantry resides. This configuration allows the bottled drinks to be accessed without the need for opening the food pantry. It is anticipated that the drinks will be used more frequently in the course of the day than would the other components of the food plan. As may be appreciated, tools such as eating utensils, knives, openers and the like may be stored in the food pantry as well.

The usage of the food pantry of the present invention may be intuitively understandable, however an explanation is provided in order to fully illustrate the invention. The food pantry is carried through the use of the carrying strap which the user can adjust for his/her personal fit. The lid provides a closure to the interior of the cooler body thereby keeping the contents protected and under the desired temperature conditions. The lid is secured by means of the straps which include snaps for keeping the lid closed relative to the cooler body. The lid has a hinge point to the rear of the cooler body that allows it to be opened from the front and then lifted to reveal the contents of the interior. The lid is itself insulated and helps to preserve the contents of the food pantry. In addition, the lid can be fitted with a lock (not shown) in order to maintain the integrity of the food stuffs and to discourage theft. The lock for the food pantry can be supplied by a number of prior art devices and is mainly a matter of selection by one skilled in the art. Nonetheless, the lock would also provide security for medications, syringes, and needles that the user may need to carry with him/her.

The timer is one of several potential tools that may be considered for use by a person who is complying with a food plan. Examples of other tools include eating utensils, can/bottle openers, scales for weighing food, dietary references, and the like. For the most part, these tools may be stored within one of the sleeve storage portion where they will be segregately retained for use. In the case of the timer, it may be one of the more valuable and least considered tools in a food plan. As may be appreciated, food plans will often encourage the participant to space meals and to plan for multiple (in excess of three) meals throughout the day. The timer becomes an essential part of the plan for the reason that it will coordinate the timing of events, whether it be the consumption of a snack or supplement, or whether it is the consumption of one of the prepare meals. In this fashion the food panty, with the timer included, helps the participant to achieve the desired effects for which the food plan was created. In the case of a medically related food plan, the usage of the timer in conjunction with the food plan could mean the maintenance of the participant's health.

The timer can be made attachable to the food pantry by using flexible fabric fasteners such as the type pioneered under the Velcro® brand. As shown in FIG. 6, the timer can be attached in a prominent location and not only provides some notice to the user of an impending time for an event, but it can be easily removed and replaced from this location. The programming of the timer is conventionally a function that is known with digital timers and does not specifically comprise a part of the present invention. One benefit of the present invention is the encouragement that it provides to a user for the use of self-prepared foods. This allows the user to take full advantage in buying foods in bulk, thereby reducing the costs associated with a food plan.

There are other variations that can be made to the food pantry of the present invention without dramatically departing from the spirit of the concept. The use of the portable food pantry in conjunction with a food plan results in an enhanced method as compared to the prior art and this usage is discussed in more detail herein.

A participant in a food plan has typically sought out advice or counseling beforehand. Sometimes this may be the result of a physician's intervention in the case of food plans that are medially oriented, or it may result from the advice and counsel from a nutritionist where the object of the food plan is nutritionally related. In any event, the food plan will typically set forth the types of food stuffs to be considered, the quantities, the frequency of consumption, and the need for supplements or other items that will facilitate the goals of the particular food plan that has been formulated. Once this information is known, the participant will typically acquire the components of the food plan (or in some cases, the components may be provided by the same service that provided the counseling). To the extent meal preparation is required, this is undertaken and the meal portions are then allocated and placed into the food containers. The food containers are insertable into the portable food pantry, and depending upon the desired configuration, this may entail stacking the food containers in whatever orientation that is compatible. It is an object of the present invention to provide food containers that are sized to fit the interior portions of the cooler body, whether these are divided by the mid-sleeve or not. As can be appreciated from the drawings, the mid-sleeve may be removed on a discretionary basis allowing for the differently sized food containers to be deployed. The cold packs have been deployed prior to the insertion of the food containers, thus ensuring the contents will stay chilled. As noted above, it is possible to store heated food stuffs in the portable food pantry, however most of the time the portable food pantry will be used to keep food and meal portions chilled.

The access to the contents of the food pantry throughout the day is made feasible by its design. In part, the appearance of the soft-sided type of cooler construction renders it somewhat invisible as a food pantry, as opposed to a conventional cooler. In addition, the layout of the food pantry allows for quick access with the contents organized in a logical manner. Lastly, all that is needed to carry out the steps of the food plan are incorporated into the food pantry. It is a complete and portable system that can go with the participant wherever needed. Additional items such as a written food plan guide, or a monitoring schedule can be supplied to augment the capabilities of the portable food pantry. In addition, medications may be included, typically under a doctor's supervision, and these are acquired and the required dosages and/or portions are stored in the portable food pantry and are accessible to the person throughout the day. The dispensing of the medications may also be timed by the timer in accordance with the requirements set forth by the supplier of the medications and/or the doctor who has prescribed them.

Typically the food pantry is used on a daily basis, consistent with the anticipated duration of the cold packs, or the duration of safe storage for the food stuffs making up the food plan. The fact that many of the supplements, tools and other aspects of the food pantry can remain in place, allows the user the advantage of only having to deal with a minimal amount of effort when replenishing the food pantry for the next day's routine.

I claim:

1. A portable food pantry for use by a person in conjunction with a food plan, the portable food pantry including a front portion, a back portion, side portions, a top with a lid portion and a bottom, where the front portion, back portion, side portions, top and bottom enclose and define a pantry interior, and where the pantry interior further includes at least one sleeve for the receipt of a cold pack, and where the side portions include at least one bottle storage portion, where the portable food pantry has a strap attached to it for carrying by the person, and where both the pantry interior and the bottle storage portions are insulated, the portable food pantry comprising:
At least one food container compatibly sized for storage in the pantry interior;
At least one storage sleeve for storing food supplements; and,
A timer/calculator for timing the intervals between meals for the person, where the timer/calculator is integrally provided with the portable food pantry.

2. The portable food pantry of claim number 1, where the portable food pantry includes at least one storage sleeve for storing medical supplies.

3. The portable food pantry of claim number 1, where the portable food pantry includes a lock for locking the lid and securing the contents of the pantry interior.

4. The portable food pantry of claim number 1, where the portable food pantry is a soft-sided type construction.

5. The portable food pantry of claim number 1, where the portable food pantry includes at least one storage sleeve for storing tools.

6. The portable food pantry of claim number 1, where the portable food pantry includes at least one bottle for storing in the bottle storage portion.

7. The portable food pantry of claim number 1, where the portable food pantry includes a plurality of food containers that are sized to contain portions of foods in accordance with a food plan calling for multiple meals for a person.

8. A portable food pantry for use by a person in conjunction with a food plan, the portable food pantry including a front portion, a back portion, side portions, a top with a lid portion and a bottom, where the front portion, back portion, side portions, top and bottom enclose and define a pantry interior, and where the pantry interior further includes at least one sleeve for the receipt of a cold pack, and where the side portions include at least one bottle storage portion including at least one bottle for storing in the bottle storage portion, where the portable food pantry has a strap attached to it for carrying by the person, and where both the pantry interior and the bottle storage portions are insulated, the portable food pantry comprising:
A plurality of food containers that are sized to contain portions of foods in accordance with a food plan calling for multiple meals for a person, where said food containers are compatibly sized for storage in the pantry interior;
At least one storage sleeve for storing food supplements;
At least one storage sleeve for storing tools; and,
A timer/calculator for timing the intervals between meals for the person, where the timer/calculator is integrally provided with the portable food pantry.

9. The portable food pantry of claim number 8, where the portable food pantry is a soft-sided type construction.

10. The portable food pantry of claim number 8, where the portable food pantry includes at least one storage sleeve for storing medical supplies.

11. The portable food pantry of claim number 8, where the portable food pantry includes a lock for locking the lid and securing the contents of the pantry interior.

12. The portable food pantry of claim number 8, where the portable food pantry is compatibly organized to support a food plan requiring multiple meals for a person by providing individual portions retained in the food containers, nutritional supplements retained in the sleeve storage, and beverages contained in at least one bottle, with a timer for marking the time for each of the multiple meals, and where the contents of the portable food pantry are kept at a desired temperature until the person is ready to use the food for a meal.

13. A method for maintaining a food plan for a person, the method including the use of a portable food pantry, including a front portion, a back portion, side portions, a top with a lid portion and a bottom, where the front portion, back portion, side portions, top and bottom enclose and define a pantry interior, and where the pantry interior further includes at least one sleeve for the receipt of a cold pack, and where the side portions include at least one bottle storage portion, where the portable food pantry has a strap attached to it for carrying by the person, and where both the pantry interior and the bottle storage portions are insulated, the steps of the method for maintaining a food plan by a person comprising:
Selecting a food plan for the person;
Acquiring the components of the food plan, and where required, preparing the components of the food plan;
Allocating portions of the components into food containers in accordance with the food plan;
Deploying cold packs in the portable food pantry;
Installing the food containers into the food pantry interior;
Setting the timer in accordance with the food plan;
Accessing the appropriate meal portion when the time is indicated, and where indicated in accordance with the food plan, accessing supplements;
Consuming the meal portion that has been indicated by the food plan, and where indicated by the food plan, consuming supplements; and,
Repeating the steps above in accordance with the food plan.

14. The method for maintaining a food plan for a person of claim number 13, including the additional steps of:
Acquiring medications in accordance with the person's medical requirements;
Selecting the appropriate quantity of medications needed by the person;
Storing the appropriate quantity of medications in the portable food pantry; and,
Accessing the medications in accordance with the prescribed requirements for the person.

15. The method for maintaining a food plan for a person of claim number 14, including the additional steps of:
Determining the schedule for dispensing of medications;
Setting the timer in accordance with the schedule for the dispensing of the medications; and,
Accessing the medications in accordance with the notice provided by the timer.

16. The method for maintaining a food plan for a person of claim number 15, including the additional steps of:
Securing the contents of the portable food pantry with a lock;
Unlocking the portable food pantry when accessing meal portions, supplements or medications; and,
Relocking the portable food pantry when the person has completed the consumption of meal portions or medications.

17. The method for maintaining a food plan for a person of claim number 16, including the additional steps of:
Leaving the bottle accessible and unlocked while the rest of the contents of the portable food pantry are secured and locked.
